(19) United States
(12) Patent Application Publication
(10) Pub. No.: US 2016/0377221 A1
(43) Pub. Date: Dec. 29, 2016

(54) INTERCHANGEABLE BRACKET FLANGE SYSTEM

(71) Applicant: Jad Honein, Seattle, WA (US)

(72) Inventor: Jad Honein, Seattle, WA (US)

(21) Appl. No.: 15/192,818

(22) Filed: Jun. 24, 2016

Related U.S. Application Data
(63) Continuation of application No. 62/495,581, filed on Jun. 26, 2015.

(51) Int. Cl. F16M 13/02; E04F 11/18

(52) U.S. Cl. CPC F16M 13/02; E04F 11/1804

(57) ABSTRACT

Interchangeable bracket flange systems can be designed to connect any type of bracket to any type of material, including wood, concrete, glass, steel, sheet rock, etc., using a wall, glass, or steel adaptor flange. The adaptor flanges, the brackets, and the interchangeable bracket flange systems as a whole can have a smooth look, with no exposed screws, when installed.

### BACKGROUND

Technical Field

The present disclosure relates generally to systems for coupling brackets to a variety of surfaces.

Description of the Related Art

Handrails and other items are often coupled to walls or other surfaces using brackets or other coupling devices. In many cases, different brackets are used depending on the material of the wall or surface to which the handrail or other item is to be coupled. Currently, manufacturers typically create different brackets for each of the different installation surface media. For example, different brackets are often manufactured and used to couple handrails to wooden surfaces, metal surfaces, and glass surfaces.

### BRIEF SUMMARY

An interchangeable bracket flange system may be summarized as comprising: a wall adaptor flange configured to connect a bracket to a wall; a glass adaptor flange configured to connect the bracket to a sheet of glass; and a steel adaptor flange configured to connect the bracket to a steel post.

The wall adaptor flange may have a first round base flange portion, the glass adaptor flange may have a second round base flange portion, and the steel adaptor flange may have a third round base flange portion. The wall adaptor flange may have a first screw coupled to and extending rearward away from a rear surface of the first round base portion, the glass adaptor flange may have a second screw coupled to and extending rearward away from a rear surface of the second round base portion, and the steel adaptor flange may have a third screw coupled to and extending rearward away from a rear surface of the third round base portion. The first screw may be configured to couple the wall adaptor flange to the wall with the first screw being hidden behind the first round base portion, the second screw may be configured to couple the glass adaptor flange to the sheet of glass with the second screw being hidden behind the second round base portion, and the third screw may be configured to couple the steel adaptor flange to the steel post with the third screw being hidden behind the third round base portion.

The wall adaptor flange may have a first adaptor flange column extending outward and forward from a center portion of the first round base flange portion, the glass adaptor flange may have a second adaptor flange column extending outward and forward from a center portion of the second round base flange portion, and the steel adaptor flange may have a third adaptor flange column extending outward and forward from a center portion of the third round base flange portion.

The first adaptor flange column may have a head portion including a hex head. The first adaptor flange column may have a head portion including a socket head. The first adaptor flange column may have a head portion including a Phillips head. The first round base flange portion may have a larger diameter than the third round base flange portion. The wall adaptor flange may be coupled to the bracket by a glue. The wall adaptor flange may be coupled to the bracket by an epoxy. The wall adaptor flange may be coupled to the bracket by a weld. The wall adaptor flange may be coupled to the bracket by a pointed head screw. The pointed head screw may extend through a portion of the bracket and engages with a channel formed in the wall adaptor flange to secure the bracket to the wall adaptor flange.

### BRIEF DESCRIPTION OF THE SEVERAL VIEWS OF THE DRAWINGS

FIG. 1 shows a wall adaptor flange.

FIG. 2 shows another wall adaptor flange.

FIG. 3 shows another wall adaptor flange.

FIG. 4 shows a first wall adaptor flange coupled to a wall and a bracket coupled to a second wall adaptor flange coupled to the wall.

FIG. 5 shows a glass adaptor flange.

FIG. 6 shows a cross-sectional view of a portion of the glass adaptor flange of FIG. 5.

FIG. 7 shows a cross-sectional view of a glass adaptor flange coupled to a sheet of glass and a bracket coupled to another glass adaptor flange coupled to the sheet of glass.

FIG. 8 is a photograph of a glass adaptor flange coupled to a sheet of glass and a bracket coupled to another glass adaptor flange coupled to the sheet of glass.

FIG. 9 shows a steel adaptor flange.

FIG. 10 shows a cross-sectional side view of the steel adaptor flange of FIG. 9.

FIG. 11 shows a side view of another steel adaptor flange.

FIG. 12 shows a top view of the steel adaptor flange of FIG. 11.

FIG. 13 shows a side view of a round post adaptor.

FIG. 14 shows a top view of the round post adaptor of FIG. 13.

FIG. 15 shows a steel adaptor flange being coupled to a steel tube with a threaded hole, and a bracket coupled to another steel adaptor flange coupled to another steel tube.

FIG. 16 shows a bracket that can be coupled to any one of the adaptor flanges described herein.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with the technology have not been shown or described in detail to avoid unnecessarily obscuring descriptions of the embodiments.

The interchangeable bracket flange systems described herein provide a modular and easy-to-use single bracket system that is configured to connect, couple, or install brackets such as handrail brackets to a wall such as a wooden or sheetrock wall, a post such as a steel post, or to a sheet of glass. The interchangeable bracket flange systems described herein include all-in-one brackets that can be used interchangeably as wooden wall brackets, metal post brackets, or glass brackets, and can be used with a variety of materials such as sheetrock, wood, steel, glass, etc. The interchangeable bracket flange systems described herein include a variety of adaptor flanges that can be fastened to a variety of materials without mounting screws or a base cover, creating a sleek and modern-looking design without sacrificing strength, and brackets that can be coupled to any one of the adaptor flanges.

A kit of interchangeable bracket flange system components can include wall adaptor flanges, used to connect brackets to wooden or sheetrock walls, such as walls with a sheetrock face and wood or steel studs, steel adaptor flanges, used to connect brackets to steel posts, glass adaptor flanges, used to connect brackets to sheets of glass, and brackets that can be coupled to any of the adaptor flanges. Each of the adaptor flanges can include a base flange portion and an adaptor flange column that projects away from a central portion of the base flange portion. Each of the adaptor flanges can also include a v-shaped channel or groove extending circumferentially around the adaptor flange column, the v-shaped channel being configured to receive or catch an end portion of a small pointed-head screw to couple the adaptor flange to a bracket during installation. A terminal end portion or head of the adaptor flange column can include a hex-head, socket-head, Phillips-head, Allen wrench head, star-shaped head, or any other type of head. The brackets can include hollow bracket columns and any one of the adaptor flanges can be coupled to a bracket by inserting the adaptor flange column of the adaptor flange into the bracket column of the bracket and securing the adaptor flange to the bracket with a small pointed-head screw.

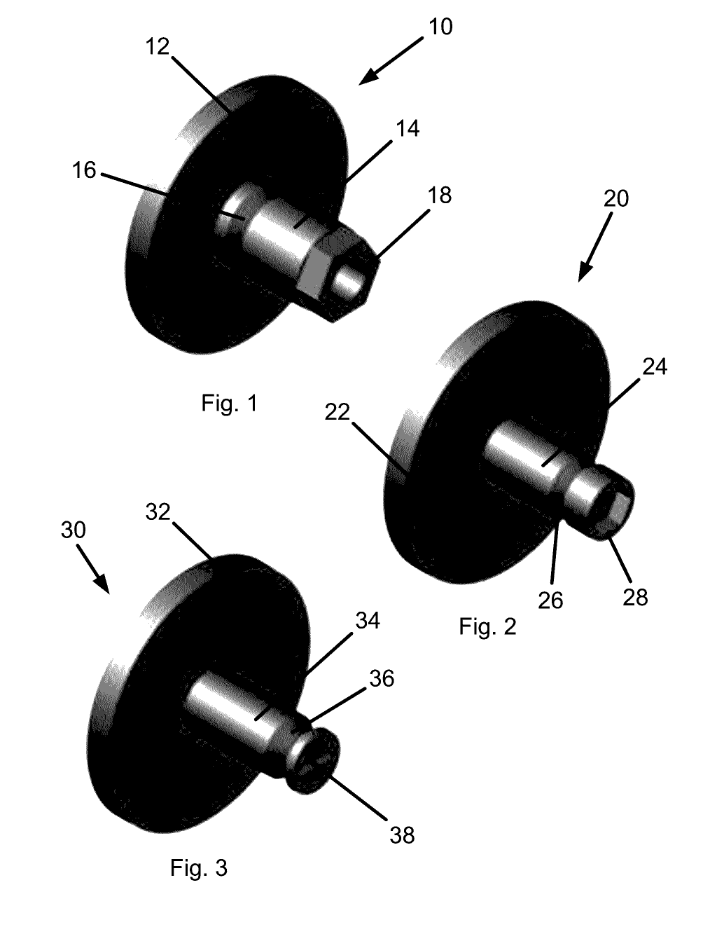

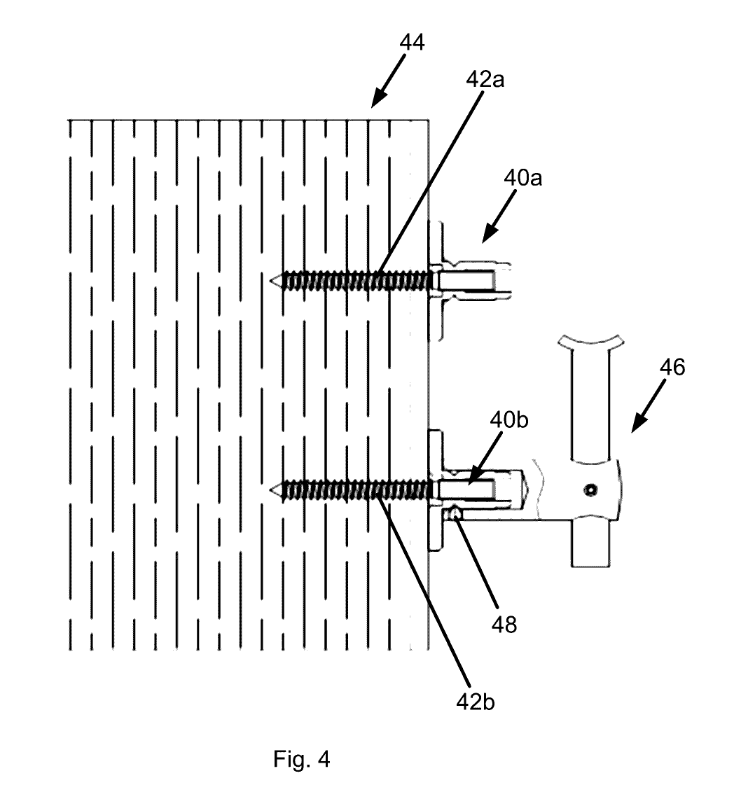

FIG. 1 illustrates a first wall adaptor flange 10 including a base flange portion 12 and a hollow adaptor flange column 14. The hollow adaptor flange column 14 includes a v-shaped channel 16 extending circumferentially around the adaptor flange column 14 at a location proximate the flange portion 12 and a hexagonal head 18. FIG. 2 illustrates a second wall adaptor flange 20 including a base flange portion 22 and an adaptor flange column 24. The adaptor flange column 24 includes a hex head or Allen wrench head 28 and a v-shaped channel 26 extending circumferentially around the adaptor flange column 24 at a location proximate the head 28. FIG. 3 illustrates a third wall adaptor flange 30 including a base flange portion 32 and an adaptor flange column 34. The adaptor flange column 34 includes a Phillips head 38 and a v-shaped channel 36 extending circumferentially around the adaptor flange column 34 at a location proximate the head 38.

The base flange portions 12, 22, and 32 can be thin pieces of metal connected to the respective adaptor flange columns 14, 24, or 34. The base flange portions 12, 22, and 32 are illustrated as round and circular but can have any suitable or aesthetically pleasing shape, such as rectangular, square, etc., which can depend on the style of the bracket to be coupled to the adaptor flange. Circular base flange portions can be desirable because they can allow a user to rotate the adaptor flange and the base flange portions as needed during installation without changing its outward appearance. As illustrated in FIG. 4, anchor screws 42a, 42b can be rigidly coupled to each of the wall adaptor flanges 40a, 40b, to connect the wall adaptor flanges 40a, 40b to a wall 44. The anchor screws 42a, 42b can have machine threads on a first portion or a first end of the anchor screws 42a, 42b, which can be threaded into complementary threads internal to the wall adaptor flanges 40a, 40b and their hollow adaptor flange columns. The anchor screws 42a, 42b can also have lag threads on a second portion or second end of the anchor screws 42a, 42b that can be threaded into the wall 44. Thus, the anchor screws 42a, 42b can be adapter screws that thread into and between the steel of the wall adaptor flanges and the wood or steel stud of the wall 44.

FIG. 4 also shows a handrail bracket 46 installed on the wall adaptor flange 40b and thereby on the wall 44. A small pointed-head screw 48 extends through a bracket column of the handrail bracket 46 and is received within and engages with a v-shaped channel of the wall adaptor flange 40b to lock the bracket 46 to the wall adaptor flange 40b and thereby to the wall 44. The handrail bracket 46 is able to withstand at least 200 pounds of force down to meet the relevant code provisions. Connecting surfaces of the wall 44 such as wood or sheetrock can be easily deformable with this amount of force over time. The wall adaptor flange 40b and a base flange portion thereof are configured to distribute such forces over a larger portion of the wall 44 to prevent or reduce deterioration or deformation of the wall 44.

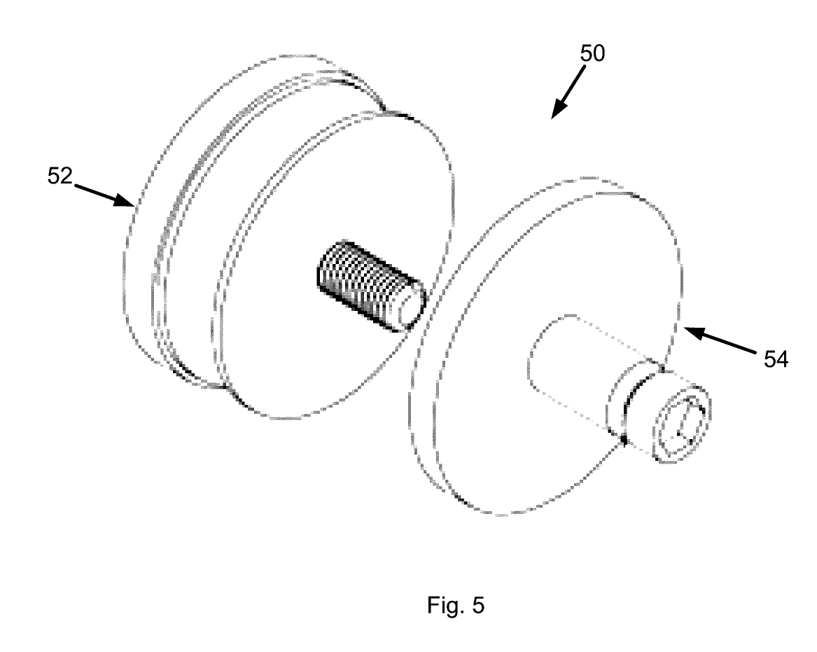

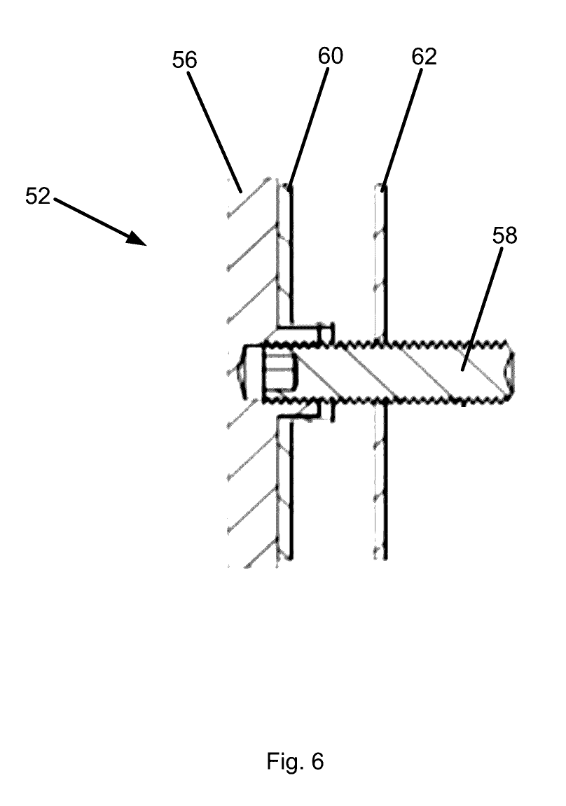

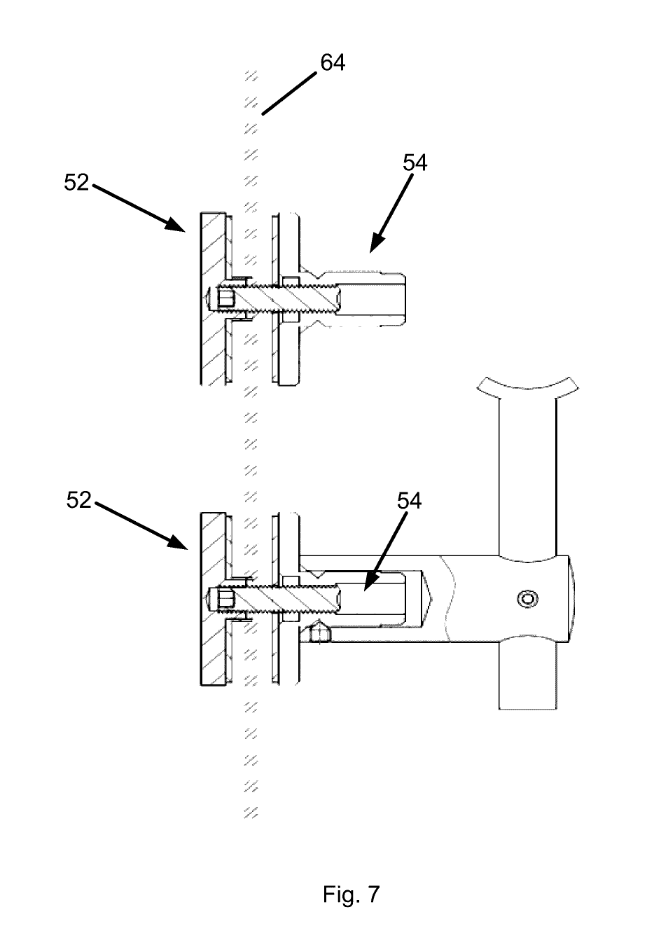

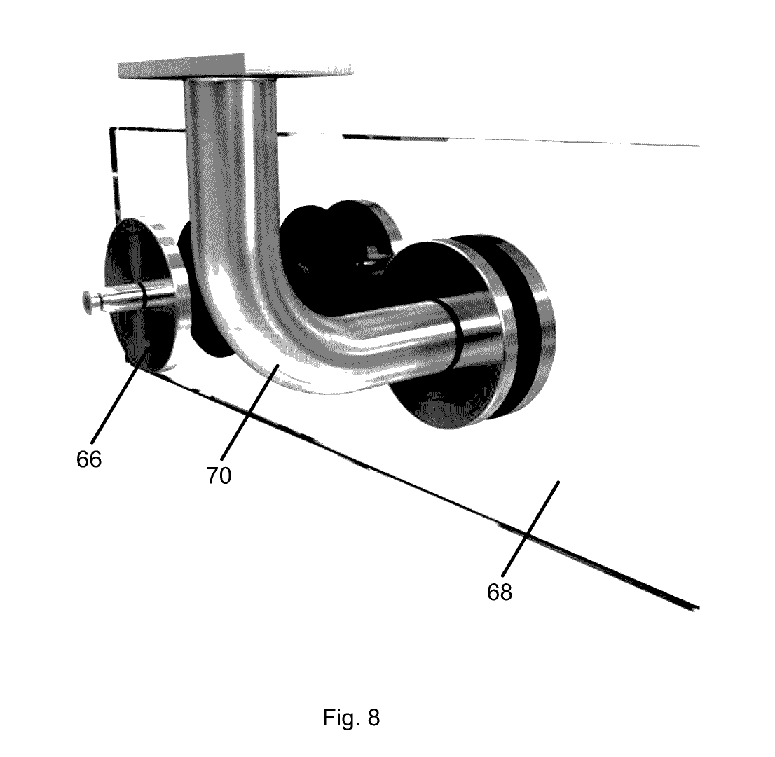

FIG. 5 illustrates a glass adaptor flange 50, which includes a rear portion 52 and a front portion 54, the front portion 54 being identical to the wall adaptor flange 20. FIG. 6 illustrates the rear portion 52 in greater detail. As seen in FIG. 6, the rear portion 52 includes a base flange portion 56 and a threaded rod 58 extending away from a central portion of the base flange portion 56. The rear portion 52 also includes a pair of rubber gaskets 60, 62, mounted on the threaded rod 58. To mount the glass adaptor flange 50 to a sheet of glass 64, as illustrated in FIG. 7, a user can position the rear portion 52 on a first side of the sheet of glass 64 with the threaded rod 58 extending through an opening in the sheet of glass 64 such that the pair of gaskets 60, 62 are on opposite sides of and pressed in direct contact against the sheet of glass 64. The user can then thread the front portion 54 of the glass adaptor flange 50 onto the end of the threaded rod 58 so that the rear portion 52 and front portion 54 are on opposite sides of the sheet of glass 64. The pair of gaskets 60 and 62 are positioned between the base flange portion 56 and the sheet of glass 64 and between the front portion 54 and the sheet of glass 64, respectively, to protect the sheet of glass. The sheet of glass can be at least one half inch thick and can be tempered or laminated. FIG. 8 illustrates a glass adaptor flange 66 coupled to a sheet of glass 68 and a bracket 70 coupled to another glass adaptor flange coupled to the sheet of glass 68.

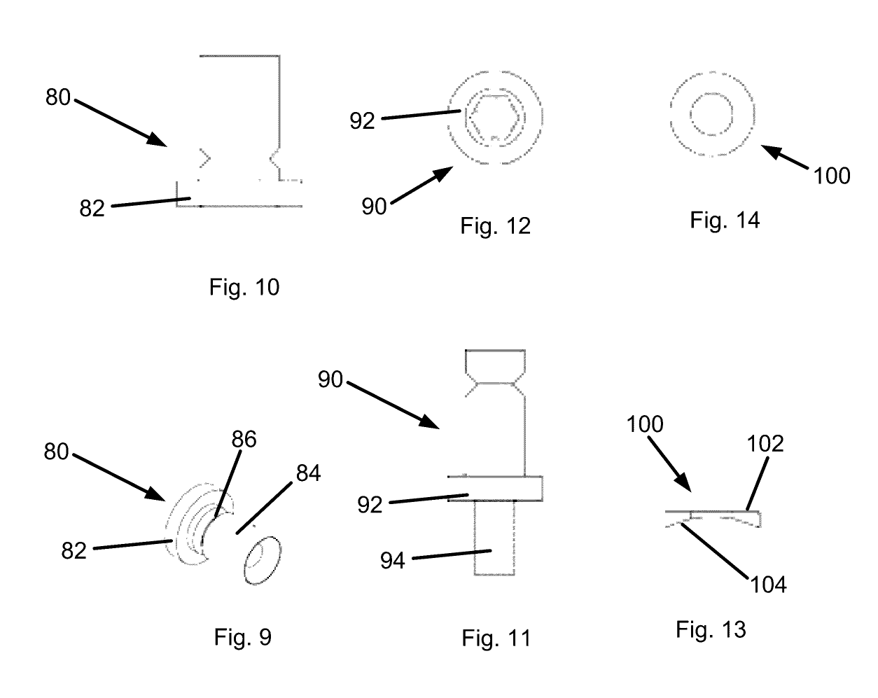

FIGS. 9 and 10 show perspective and cross-sectional side views, respectively, of a first steel adaptor flange 80. The first steel adaptor flange 80 is similar to the wall adaptor flange 10 but has a base flange portion 82 having a smaller diameter than the base flange portion 12 of the wall adaptor flange 10.

The base flange portion 82 has a smaller diameter than the base flange portion 12 because the base flange portion 82 is configured to be coupled to steel, and steel posts in particular, rather than to wood or sheetrock walls. Thus, due to the greater strength and rigidity of steel compared to wood and sheetrock, the base flange portion 82 can distribute forces over areas smaller than for the base flange portion 12 while still preventing or reducing deterioration. Further, the smaller base flange portion 82 can look more aesthetically pleasing than the base flange portion 12 when coupled to a post. The steel adaptor flange 80 also includes an adaptor flange column 84 and a v-shaped channel 86 extending circumferentially around the adaptor flange column 84 at a location proximate the flange portion 82.

FIGS. 11 and 12 show a side view and a top view, respectively, of a second steel adaptor flange 90. The second steel adaptor flange 90 is identical to the wall adaptor flange 20 except that it includes a base flange portion 92 having a smaller diameter than the base flange portion 22. FIGS. 11 and 12 illustrate that a first portion of a threaded rod 94 can be welded to the second steel adaptor flange 90 or threaded into an internal hollow portion of the second steel adaptor flange 90 such that a second portion of the threaded rod 94 extends out away from the steel adaptor flange 90 to be engaged with a steel post. FIGS. 13-14 show side and top views, respectively, of a round post adaptor 100. The round post adaptor 100 can be a washer with a first, flat surface 102 and a second, concave surface 104. The round post adaptor 100 can be positioned on the threaded rod 94 with the flat surface 102 against the base flange portion 92 to allow the steel adaptor flange 90 to be snugly coupled to a round steel post. To couple a bracket to a steel post, a user can position a steel post having a hole formed in a side surface thereof in a desired location. The hole in the steel post can be threaded (such as can be achieved by a flow drilling process) to receive the threaded rod 94 or the hole can be unthreaded and the user can insert a rivet nut into the unthreaded hole to receive the threaded rod 94. A surface of a base flange portion of a steel adaptor flange configured to engage a steel post and the curved surface 104 of the round post adaptor 100 can each include a recessed area to accommodate a flange of a rivet nut in case a rivet nut is used. Once a steel adaptor flange is mounted to the surface of the steel post, the user can couple a bracket to the steel adaptor flange as described above, using a small pointed-head screw.

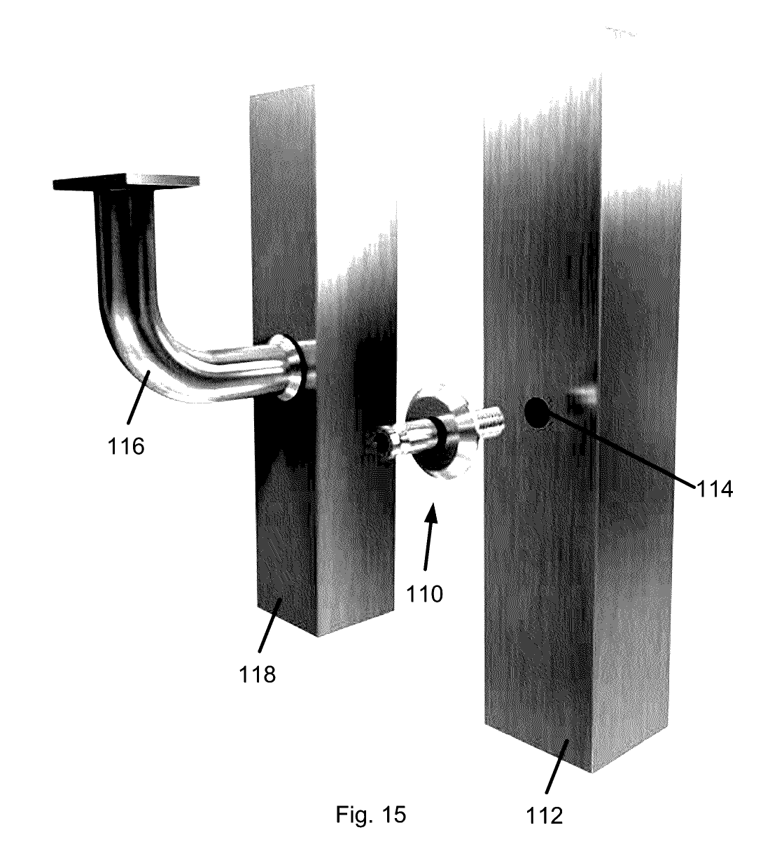

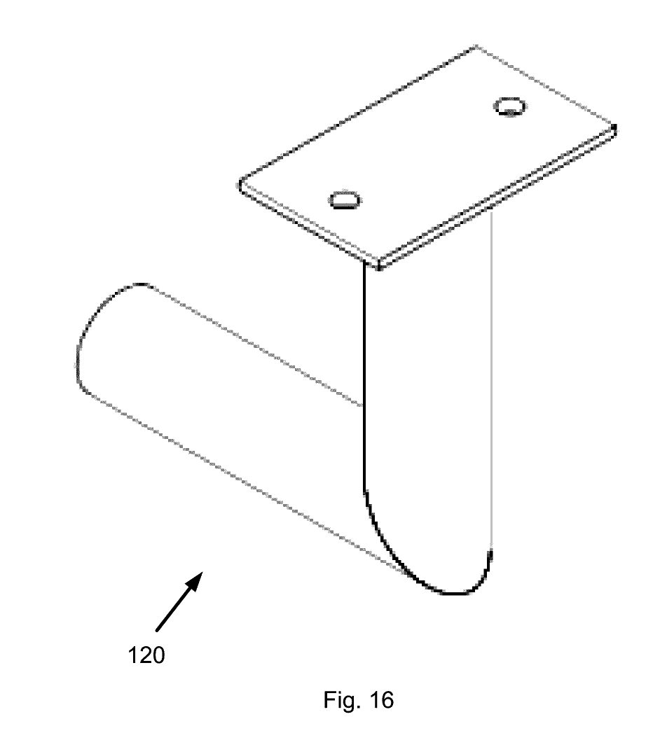

FIG. 15 shows a steel adaptor flange 110 being coupled to a steel tube 112 having a threaded hole 114 in a side surface thereof, and a bracket 116 that is coupled to another steel adaptor flange coupled to another steel tube 118. FIG. 16 shows a bracket 120 that can be coupled to any one of the adaptor flanges described herein.

U.S. patent application Ser. No. 14/751,505, filed Jun. 26, 2015, to which this application claims priority, is hereby incorporated herein by reference in its entirety. The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An interchangeable bracket flange system comprising:
a wall adaptor flange configured to connect a bracket to a wall;
a glass adaptor flange configured to connect the bracket to a sheet of glass; and
a steel adaptor flange configured to connect the bracket to a steel post.

2. The interchangeable bracket flange system of claim 1 wherein the wall adaptor flange has a first round base flange portion, the glass adaptor flange has a second round base flange portion, and the steel adaptor flange has a third round base flange portion.

3. The interchangeable bracket flange system of claim 2 wherein the wall adaptor flange has a first screw coupled to and extending rearward away from a rear surface of the first round base portion, the glass adaptor flange has a second screw coupled to and extending rearward away from a rear surface of the second round base portion, and the steel adaptor flange has a third screw coupled to and extending rearward away from a rear surface of the third round base portion.

4. The interchangeable bracket flange system of claim 3 wherein the first screw is configured to couple the wall adaptor flange to the wall with the first screw being hidden behind the first round base portion, the second screw is configured to couple the glass adaptor flange to the sheet of glass with the second screw being hidden behind the second round base portion, and the third screw is configured to couple the steel adaptor flange to the steel post with the third screw being hidden behind the third round base portion.

5. The interchangeable bracket flange system of claim 2 wherein the wall adaptor flange has a first adaptor flange column extending outward and forward from a center portion of the first round base flange portion, the glass adaptor flange has a second adaptor flange column extending outward and forward from a center portion of the second round base flange portion, and the steel adaptor flange has a third adaptor flange column extending outward and forward from a center portion of the third round base flange portion.

6. The interchangeable bracket flange system of claim 5 wherein the first adaptor flange column has a head portion including a hex head.

7. The interchangeable bracket flange system of claim 5 wherein the first adaptor flange column has a head portion including a socket head.

8. The interchangeable bracket flange system of claim 5 wherein the first adaptor flange column has a head portion including a Phillips head.

9. The interchangeable bracket flange system of claim 2 wherein the first round base flange portion has a larger diameter than the third round base flange portion.

10. The interchangeable bracket flange system of claim 1 wherein the wall adaptor flange is coupled to the bracket by a glue.

11. The interchangeable bracket flange system of claim 1 wherein the wall adaptor flange is coupled to the bracket by an epoxy.

12. The interchangeable bracket flange system of claim 1 wherein the wall adaptor flange is coupled to the bracket by a weld.

13. The interchangeable bracket flange system of claim 1 wherein the wall adaptor flange is coupled to the bracket by a pointed head screw.

14. The interchangeable bracket flange system of claim 13 wherein the pointed head screw extends through a portion of the bracket and engages with a channel formed in the wall adaptor flange to secure the bracket to the wall adaptor flange.
